(19) United States
(12) Patent Application Publication
(10) Pub. No.: US 2026/0148715 A1
(43) Pub. Date: May 28, 2026

(54) ELECTRO-OPTICAL DEVICE AND ELECTRONIC APPARATUS

(71) Applicant: SEIKO EPSON CORPORATION, Tokyo (JP)

(72) Inventor: Yuki YASHIRO, CHITOSE-SHI (JP)

(73) Assignee: SEIKO EPSON CORPORATION, Tokyo (JP)

(21) Appl. No.: 19/394,912

(22) Filed: Nov. 20, 2025

(30) Foreign Application Priority Data
Nov. 22, 2024 (JP) 2024-203739

(51) Int. Cl. G09G 3/36

(52) U.S. Cl. CPC G09G 3/3696; G09G 3/3688; G09G 2300/0426; G09G 2300/0871

(57) ABSTRACT

An electro-optical device includes: a pixel circuit including a liquid crystal element in which liquid crystal is sandwiched between a pixel electrode and a common electrode, and a first transistor provided between the pixel electrode and a data line to which a data signal is supplied; a second transistor provided between a terminal that receives input of the data signal and the data line; and a level shift circuit that level-shifts, during a period in which the second transistor is in an off-state, a voltage of the data signal supplied to the data line during a period in which the second transistor is in an on-state.

The present application is based on, and claims priority from JP Application Serial Number 2024-203739, filed Nov. 22, 2024, the disclosure of which is hereby incorporated by reference herein in its entirety.

### BACKGROUND

### 1. Technical Field

The present disclosure relates to an electro-optical device and an electronic apparatus.

### 2. Related Art

In a liquid crystal element as an example of a display element, liquid crystal is sandwiched between a pixel electrode and a common electrode for each pixel. In the liquid crystal element, alternating-current driving in which a voltage applied to the pixel electrode is alternately switched between a high (positive) voltage and a low (negative) voltage with respect to the common electrode is used in principle. In a configuration in which the voltage applied to the common electrode is constant, the voltage amplitude of a data signal applied to the pixel electrode has both positive and negative polarities, and thus a withstand voltage corresponding to the voltage amplitude is required for component elements in a data line drive circuit that supplies the data signal.

Therefore, a technique is known in which the common electrode is set at a low voltage when a positive voltage is applied to the pixel electrode, the common electrode is set at a high voltage when a negative voltage is applied to the pixel electrode, and the voltage of the common electrode is alternately switched according to the polarity (for example, refer to JP-A-2010-113274).

JP-A-2010-113274 is an example of the related art.

However, the common electrode is common to all the pixels, and the parasitic capacitance of the common electrode is large. In the technique of switching the voltage of the common electrode, not only the display quality is adversely affected, but also the power consumption increases.

### SUMMARY

To solve the above problem, an electro-optical device according to an aspect of the present disclosure includes: a pixel circuit including a liquid crystal element in which liquid crystal is sandwiched between a pixel electrode and a common electrode, and a first switch provided between the pixel electrode and a data line to which a data signal is supplied; a second switch provided between a terminal that receives input of the data signal and the data line; and a level shift circuit that level-shifts, during a period in which the second switch is in an off-state, a voltage of the data signal supplied to the data line during a period in which the second switch is in an on-state

### BRIEF DESCRIPTION OF THE DRAWINGS

FIG. 1 is a perspective view showing an electro-optical device according to an embodiment.

FIG. 2 is a block diagram showing a configuration of the electro-optical device.

FIG. 3 is a plan view showing an arrangement of elements in the electro-optical device.

FIG. 4 shows a configuration of a pixel circuit in the electro-optical device.

FIG. 5 shows a configuration of a level shift circuit in the electro-optical device.

FIG. 6 is a timing chart showing an operation in a negative polarity writing period in the electro-optical device.

FIG. 7 is a timing chart showing an operation of a positive polarity writing period in the electro-optical device.

FIG. 8 shows an equivalent circuit of a main part in the electro-optical device.

FIG. 9 shows the operation in the negative polarity writing period in the electro-optical device.

FIG. 10 shows a level shift operation in the positive polarity writing period.

FIG. 11 shows the level shift operation in the positive polarity writing period.

FIG. 12 shows a voltage range in negative polarity writing in the electro-optical device.

FIG. 13 shows a voltage range in positive polarity writing in the electro-optical device.

FIG. 14 is a plan view showing an arrangement of elements in an electro-optical device according to a modification.

FIG. 15 shows a projection-type display apparatus to which the electro-optical device is applied.

### DESCRIPTION OF EMBODIMENTS

A projection-type display apparatus according to an embodiment will hereinafter be described with reference to the drawings. Note that, in the drawings, dimensions and scales of the respective parts are appropriately made different from real ones. Further, the following embodiment is a preferable specific example of the present disclosure and therefore various technically preferable limitations are imposed thereon, however, the scope of the present disclosure is not limited to the embodiment unless there is a description that the present disclosure is limited thereto in particular in the following description.

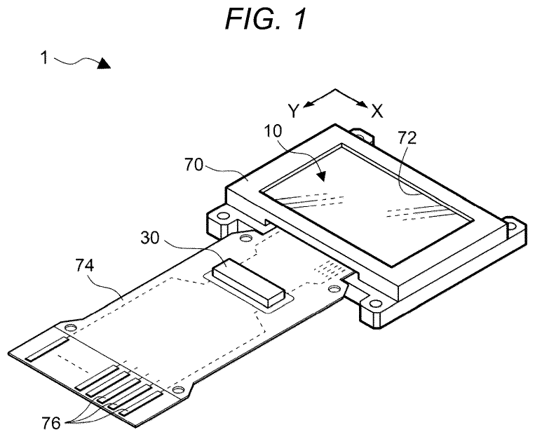

FIG. 1 is a perspective view illustrating a configuration of a module 1 including an electro-optical device 10 according to an embodiment.

The electro-optical device 10 is, for example, a transmissive liquid crystal panel used as a light valve of the projection-type display apparatus. The electro-optical device 10 is housed in a frame-shaped case 70 having an opening 72.

One end of an FPC board 74 is coupled to the electro-optical device 10. Note that FPC is an abbreviation for flexible printed circuits. A plurality of terminals 76 are provided at the other end of the FPC board 74, and are coupled to an upper circuit (not illustrated).

A display control circuit 30 of a semiconductor chip is mounted on the FPC board 74 by face-down bonding, and video data is supplied from the upper circuit via the plurality of terminals 76 in synchronization with a synchronizing signal. The video data defines the gray levels of pixels in a rectangular image to be displayed by, for example, 8 bits.

In the drawings, an X direction is a longitudinal direction of an image to be generated and is an extension direction of scanning lines to be described later. A Y direction is a lateral direction in the image and is an extension direction of data lines.

When the electro-optical device 10 is used as a light valve of the projection-type display apparatus, as will be described later, transmission images by three electro-optical devices 10 corresponding to primary colors of R (red), G (green), and B (blue) are synthesized to express a color image.

Therefore, the pixel as a minimum unit of the color image is represented by additive color mixing by a red sub-pixel by the electro-optical device corresponding to R, a green sub-pixel by the electro-optical device corresponding to G, and a blue sub-pixel by the electro-optical device corresponding to B. However, when it is not necessary to specify the colors of the sub-pixels of red, green, and blue or when only light and dark matter, the expression as sub-pixels is not necessary. Therefore, in this description, the sub-pixels of red, green, and blue are also simply described as “pixels”.

The synchronizing signal includes a vertical synchronizing signal for instructing the pixel circuits arranged in the display region 100 to start vertical scanning, a horizontal synchronizing signal for instructing the pixels to start horizontal scanning, and a clock signal indicating the timing of video data for one pixel.

The display control circuit 30 processes the video data and the synchronizing signal and outputs a data signal and a control signal necessary for driving the electro-optical device 10. The data signal is a signal obtained by converting the video data into an analog signal, and the control signal is a signal for controlling vertical scanning and horizontal scanning in the electro-optical device 10.

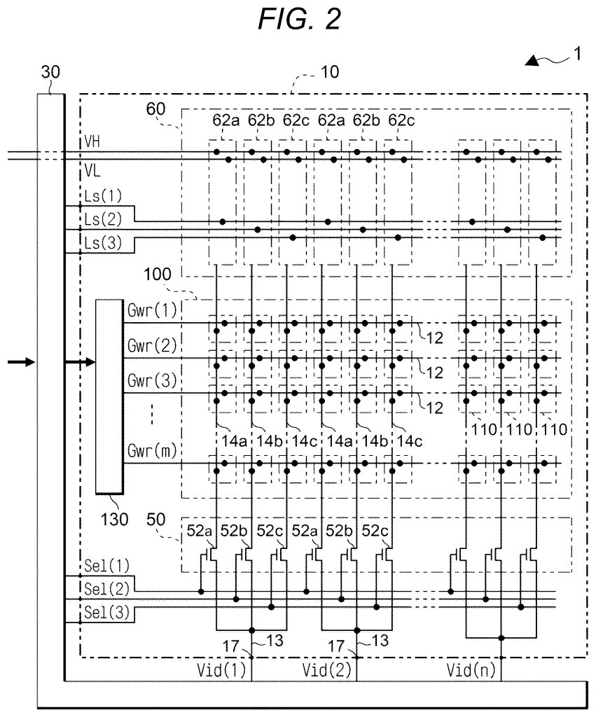

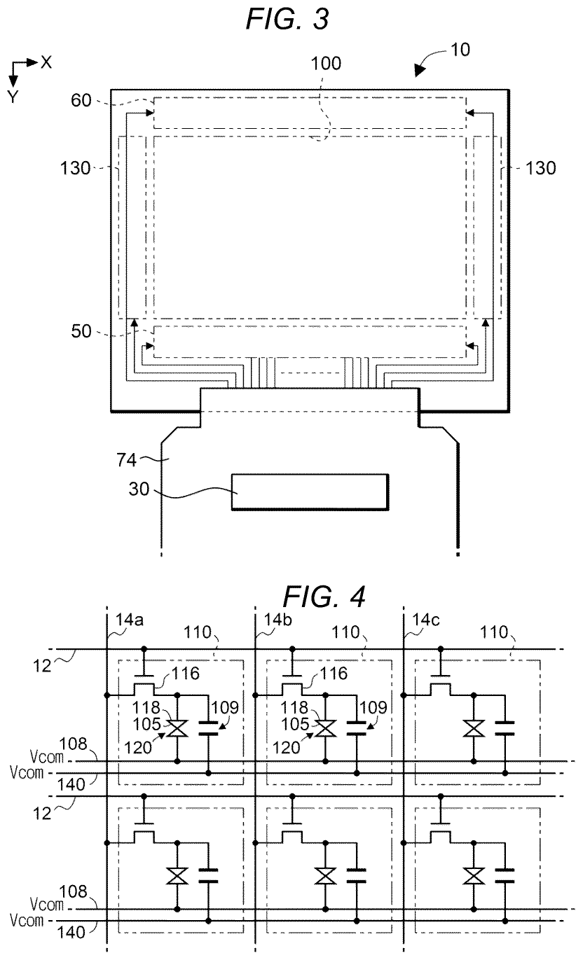

FIG. 2 is a block diagram illustrating an electrical configuration of the module 1, and FIG. 3 is a plan view illustrating an arrangement of elements in the electro-optical device 10. As described above, the module 1 includes the electro-optical device 10 and the display control circuit 30.

The electro-optical device 10 has a configuration in which liquid crystal is sealed by an element substrate on which thin film transistors and the like are formed and a counter substrate on which a common electrode is formed. In the element substrate, a distribution circuit 50, an auxiliary circuit 60, and scanning line drive circuits 130 are provided at the periphery of the rectangular display region 100.

Specifically, as illustrated in FIG. 3, in the element substrate of the electro-optical device 10, the distribution circuit 50 is provided between one side to which the FPC board 74 is coupled and the display region 100, that is, on the rectangular lower side of the display region 100 in a plan view.

The auxiliary circuit 60 is provided on the side opposite to the distribution circuit 50 with respect to the display region 100, that is, on the rectangular upper side of the display region 100 in the plan view. The scanning line drive circuits 130 are provided on the remaining two sides at the periphery of the display region 100, that is, on both left and right sides in the rectangle of the display region 100 in the plan view.

In the description, the plan view refers to a view of the element substrate from a normal direction of the substrate surface in the counter substrate through the counter substrate.

In the display region 100, pixel circuits 110 corresponding to pixels of an image to be displayed are arranged in a matrix. Specifically, in the display region 100, m scanning lines 12 are provided to extend in the horizontal direction in the drawing, and data lines 14a, 14b, and 14c are provided to extend in the vertical direction in the drawing and to be kept electrically insulated from the scanning lines 12.

In the present embodiment, the data lines are grouped into three data lines 14a, 14b, and 14c. When the number of groups is n, the total number of data lines is (3n) in the present embodiment.

The pixel circuits 110 are provided corresponding to the intersections of the m scanning lines 12 and the data lines 14a, 14b, and 14c. Therefore, in the present embodiment, the pixel circuits 110 are arranged in a matrix of vertical m rows×horizontal (3n) columns.

Here, m is an integer of 2 or more. n is an integer of 2 or more. In the present embodiment, m<(3n).

In order to generalize and describe the rows of the scanning lines 12 and the rows in the pixel circuits 110 of the matrix array, an integer i from 1 to m is used. For example, the scanning lines 12 may be referred to as first, second, third, . . . , (i−1)-th, i-th, . . . , (m−1)-th, and m-th rows in order from the top in the drawing.

Similarly, in order to generalize and describe the columns of the data lines and the columns in the pixel circuits 110 of the matrix array, an integer j from 1 to n is used. For example, in order to distinguish the data lines, the data lines may be referred to as first, second, third, . . . , (3j−2)-th, (3j−1)-th, (3j)-th, . . . , (3n−2)-th, (3n−1)-th, and (3n)-th columns in order from the left in the drawing.

Regarding the data lines 14a, 14b, and 14c or columns, the j-th group may be described with the (3j−2)-th column in a first series, the (3j−1)-th column in a second series, and the (3j)-th column in a third series. In other words, in the j-th group, the data line 14a in the first series is the (3j−2)-th column, the data line 14b in the second series is the (3j−1)-th column, and the data line 14c in the third series is the (3j)-th column.

The display control circuit 30 processes the video data and the synchronizing signal supplied from the upper circuit, and outputs data signals Vid(1), Vid(2), Vid(3), . . . , and Vid(n) and control signals Sel(1) to Sel(3) and Ls(1) to Ls(3) in addition to the control signals to the scanning line drive circuits 130.

The data signals Vid(1), Vid(2), Vid(3), . . . , and Vid(n) are supplied to the electro-optical device 10 via n terminals 17 and n data signal lines 13. The data signals Vid(1), Vid(2), Vid(3), . . . , Vid(n) will be generalized and described. The data signal Vid(j) is a signal having a voltage corresponding to the gray levels of three pixels corresponding to the intersection of the three data lines 14a, 14b, and 14c belonging to the j-th group and the scanning line 12 for horizontal scanning. In other words, the voltage of the data signal Vid(j) time-divisionally changes in the horizontal scanning period according to the gray levels of the three pixels.

The control signal Sel(1) is a signal for selecting the data line 14a in the first series. Similarly, the control signal Sel(2) is a signal for selecting the data line 14b in the second series, and the control signal Sel(3) is a signal for selecting the data line 14c in the third series.

The control signal Ls(1) is a signal for instructing a level shift for the data line 14a in the first series. Similarly, the control signal Ls(2) is a signal for instructing a level shift for the data line 14b in the second series, and the control signal Ls(3) is a signal for instructing a level shift for the data line 14c in the third series.

The scanning line drive circuit 130 individually supplies scanning signals to the m rows of scanning lines 12 under the control of the display control circuit 30. Here, the scanning signal supplied to the scanning line 12 in the first row is denoted by Gwr(1), and subsequently the scanning signals supplied to the scanning lines 12 in the second, third, . . . , (i−1)-th, i-th, . . . , (m−1)-th, and the m-th rows are denoted by Gwr(2), Gwr(3), . . . , Gwr(i−1), Gwr(i), . . . , Gwr(m−1), and Gwr(m), respectively.

The display control circuit 30 outputs various control signals for controlling the scanning line drive circuits 130, but the control signals to the scanning line drive circuits 130 are not important in this case, and thus only signal paths are illustrated.

The distribution circuit 50 is a circuit (demultiplexer) that distributes the data signal supplied to the data signal line 13 via the terminal 17 to the three data lines 14a, 14b, and 14c according to the control signals Sel(1) to Sel(3). Specifically, in the distribution circuit 50, the transistors 52a, 52b, and 52c are provided in order corresponding to the first series, the second series, and the third series.

The transistors 52a, 52b, and 52c are N-channel thin film transistors similar to the transistors in the pixel circuit 110. The transistors 52a, 52b, and 52c will be described with a focus on the j-th group.

The data signal Vid(j) is supplied to the data signal line 13 corresponding to the j-th group via the terminal 17. The data signal line 13 branches into three and is coupled to the input terminals (source nodes) of the transistors 52a, 52b, and 52c.

In the j-th group, in the transistor 52a in the first series, the output terminal (drain node) is coupled to the data line 14a in the first series in the j-th group. The control signal Sel(1) is supplied to the gate node of the transistor 52a.

Similarly, in the j-th group, the output terminal of the transistor 52b in the second series is coupled to the data line 14b in the second series in the j-th group. The control signal Sel(2) is supplied to the gate node of the transistor 52b.

In the j-th group, the output terminal of the transistor 52c in the third series is coupled to the data line 14c in the third series in the j-th group. The control signal Sel(3) is supplied to the gate node of the transistor 52c.

The auxiliary circuit 60 is a collection circuit of level shift circuits 62a provided corresponding to the first series, level shift circuits 62b provided corresponding to the second series, and level shift circuits 62c provided corresponding to the third series.

The level shift circuit 62a is a circuit that level-shifts the voltage of the data signal sampled on the data line 14a in accordance with the control signal Ls(1) when the transistor 52a is in the on-state.

Similarly, the level shift circuit 62b is a circuit that level-shifts the voltage of the data signal sampled on the data line 14b in accordance with the control signal Ls(2) when the transistor 52b is in the on-state.

The level shift circuit 62c is a circuit that level-shifts the voltage of the data signal sampled on the data line 14c in accordance with the control signal Ls(3) when the transistor 52c is in the on-state.

In the present description, “on-state” of the transistor or a switch refers to a state in which the source node and the drain node of the transistor or two points of the switch are electrically closed to be in a low impedance state. Further, “off-state” of the transistor or the switch refers to a state in which the source node and the drain node or the two points of the switch are electrically opened to be in a high impedance state.

FIG. 2 shows the electrical configuration of the electro-optical device 10 in an easy-to-understand manner. The actual arrangement of the respective elements in the electro-optical device 10 is as described with reference to FIG. 3.

In FIG. 3, scanning signals are supplied to the scanning lines 12 from both left and right ends by the scanning line drive circuits 130 provided on the left and right sides of the display region 100. This configuration is to suppress the influence of the delay of the scanning signals on display as compared with a case where the scanning signals are supplied only from one end.

Although the control signals Sel(1) to Sel(3) supplied to the distribution circuit 50 are supplied from the left end in FIG. 2, similarly to the scanning signals, the control signals are supplied from both left and right ends in order to suppress the influence of the delay as illustrated in FIG. 3.

Although the control signals Ls(1) to Ls(3) supplied to the auxiliary circuit 60 are supplied from the left end in FIG. 2, similarly to the scanning signals, the control signals are supplied from both left and right ends in order to suppress the influence of the delay as illustrated in FIG. 3.

FIG. 4 shows equivalent circuits of a total of six (2×3) pixel circuits 110 corresponding to intersections of the two adjacent scanning lines 12 and the three data lines 14a, 14b, and 14c belonging to the same group.

As illustrated in the drawing, the pixel circuit 110 includes a transistor 116 and a liquid crystal element 120. The transistor 116 is, for example, an N-channel thin film transistor. In the pixel circuit 110, the gate node of the transistor 116 is coupled to the scanning line 12, the source node thereof is coupled to one of the data lines 14a, 14b, and 14c, and the drain node thereof is coupled to a pixel electrode 118 and one end of a storage capacitor 109.

In the present description, “electrical coupling” or simply “coupling” means direct or indirect coupling or joint between two or more elements, and includes, for example, coupling between two or more elements via different wiring layers and contact holes even not directly on a semiconductor substrate.

A common electrode 108 is commonly provided in all the pixel circuits 110 so as to face the pixel electrodes 118. In the present embodiment, the common electrode 108 is maintained at a temporally substantially constant voltage Vcom. Liquid crystal 105 is sandwiched between the pixel electrode 118 and the common electrode 108. Therefore, for each pixel circuit 110, the pixel electrode 118, the common electrode 108, and the liquid crystal 105 form the liquid crystal element 120.

The storage capacitor 109 is electrically coupled in parallel with the liquid crystal element 120, and the other end thereof is coupled to a capacitor wire 140. The capacitor wire 140 is maintained at a temporally constant potential, for example, the same voltage Vcom as that of the common electrode 108.

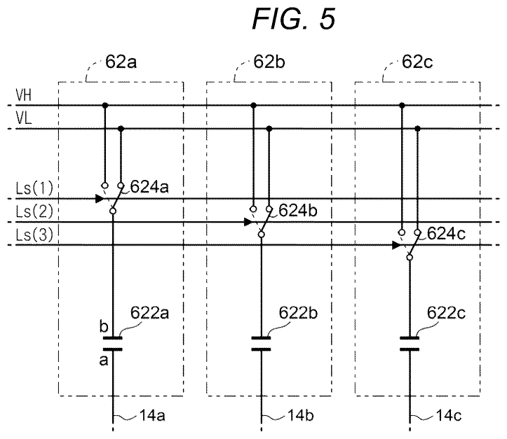

FIG. 5 shows the level shift circuits 62a, 62b, and 62c in the auxiliary circuit 60.

The level shift circuit 62a includes a capacitive element 622a having one end a and the other end b, and a double-throw switch 624a.

One end a of the capacitive element 622a is coupled to the data line 14a in the first series.

The switch 624a selects either voltage VL or VH in accordance with control signal Ls(1), and applies the selected voltage to the other end b of capacitive element 622a. Specifically, the switch 624a selects the voltage VL as indicated by the solid line when the control signal Ls(1) is at the L level, and selects the voltage VH as indicated by the broken line when the control signal is at the H level.

The voltages VL and VH have a relationship VL<VH, and the details will be described later.

In the present description, a voltage refers to a potential difference between two points, but unless otherwise specified, an L level, which is a ground potential, is used as a reference.

Further, the switch 624a can be formed with, for example, two N-channel transistors. Specifically, although not particularly illustrated, one transistor is provided between a power supply line of the voltage VH and the data line 14a, the on-state and the off-state of the one transistor are controlled according to the control signal Ls(1), the other transistor is provided between a power supply line of the voltage VL and the data line 14a, and the on-state and the off-state of the other transistor are controlled according to a signal obtained by inverting the control signal Ls(1) by a NOT circuit.

Similarly to the level shift circuit 62a, the level shift circuit 62b includes a capacitive element 622b and a double-throw switch 624b. One end of the capacitive element 622b is coupled to the data line 14b in the second series. The switch 624b selects the voltage VL when the control signal Ls(2) is at the L level, selects the voltage VH when the control signal is at the H level, and applies the selected voltage to the other end of the capacitive element 622b.

Similarly to the level shift circuit 62a, the level shift circuit 62c includes a capacitive element 622c and a double-throw switch 624c. One end of the capacitive element 622c is coupled to the data line 14c in the third series. The switch 624c selects the voltage VL when the control signal Ls(3) is at the L level, selects the voltage VH when the control signal is at the H level, and applies the selected voltage to the other end of the capacitive element 622c.

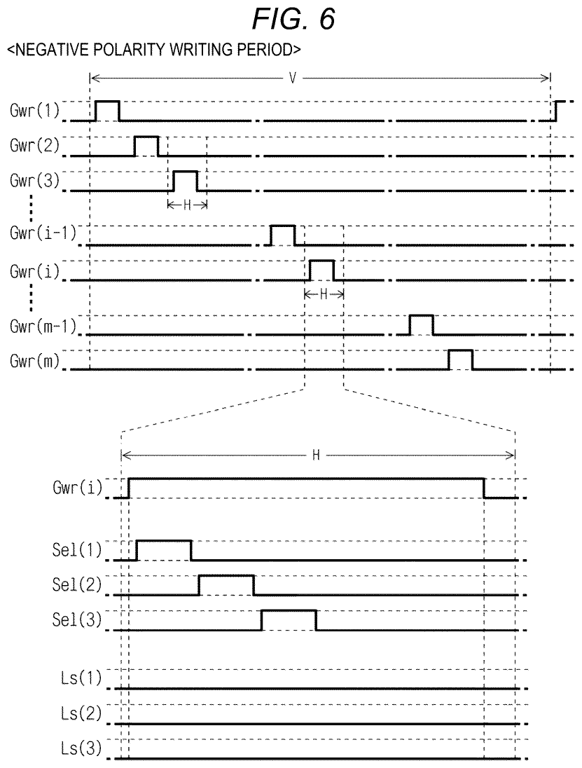

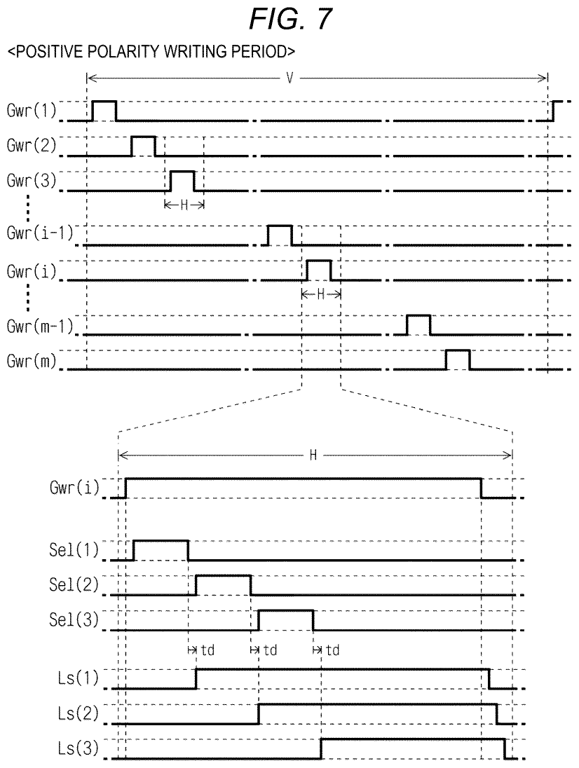

FIGS. 6 and 7 are timing charts illustrating operations of the electro-optical device 10. Specifically, FIG. 6 illustrates the operation in a frame period (V) for negative polarity writing in the electro-optical device 10, and FIG. 7 illustrates the operation in a frame period (V) for positive polarity writing in the electro-optical device 10. The negative polarity writing refers to application of a data signal having a voltage lower than the voltage Vcom applied to the common electrode 108 to the pixel electrode 118 of the liquid crystal element 120. In contrast, the positive polarity writing refers to application of a data signal having a voltage higher than the voltage Vcom to the pixel electrode 118.

The negative polarity writing and the positive polarity writing are alternately executed, for example, for each frame period (V).

In the present description, one frame (V) period refers to a period required to display one frame of an image designated by video data supplied from an upper circuit. When a length of the period of one frame (V) is the same as that of a vertical synchronization period, for example, when the frequency of the vertical synchronizing signal contained in a synchronizing signal Sync is 60 Hz, the length is 16.7 milliseconds corresponding to one cycle of the vertical synchronizing signal.

In the electro-optical device 10, in the frame period(V) for negative polarity writing and the frame period(V) for positive polarity writing, scanning is performed on the m rows of scanning lines 12 one row at a time in the order of first, second, third, . . . , and m-th lines.

Specifically, as shown in FIGS. 6 and 7, the scanning signals Gwr(1), Gwr(2), . . . , Gwr(i−1), Gwr(i), . . . , Gwr(m−1), and Gwr(m) sequentially and exclusively become the H level for each horizontal scanning period (H) by the scanning line drive circuit 130.

In the embodiment, periods in which adjacent scanning signals among the scanning signals Gwr(1) to Gwr(m) are at the H level are temporally isolated from each other. Specifically, the scanning signal Gwr(i−1) changes from the H level to the L level, and then, the next scanning signal Gwr(i) becomes the H level after a period. The period corresponds to a horizontal blanking period.

The horizontal scanning period (H) is a time interval during which the scanning signals Gwr(1) to Gwr(m) are at the H level in order, but for the sake of convenience in the drawing, a start time of the horizontal scanning period (H) is set to substantially a center of the horizontal blanking period.

The control signals Sel(1) to Sel(3) sequentially and exclusively become the H level in the period in which the scanning signal Gwr(1) to Gwr (m) are at the H level in the frame period(V) for negative polarity writing and the frame period(V) for positive polarity writing.

The control signals Ls(1) to Ls(3) are constant at the L level in the frame period (V) for negative polarity writing. In contrast, in the frame period (V) for positive polarity writing, the control signals Sel(1) to Sel(3) sequentially become the H level at times delayed by time td from times when changing from the H level to the L level, and sequentially become the L level in the horizontal blanking period after the scanning signal Gwr(i) changes from the H level to the L level.

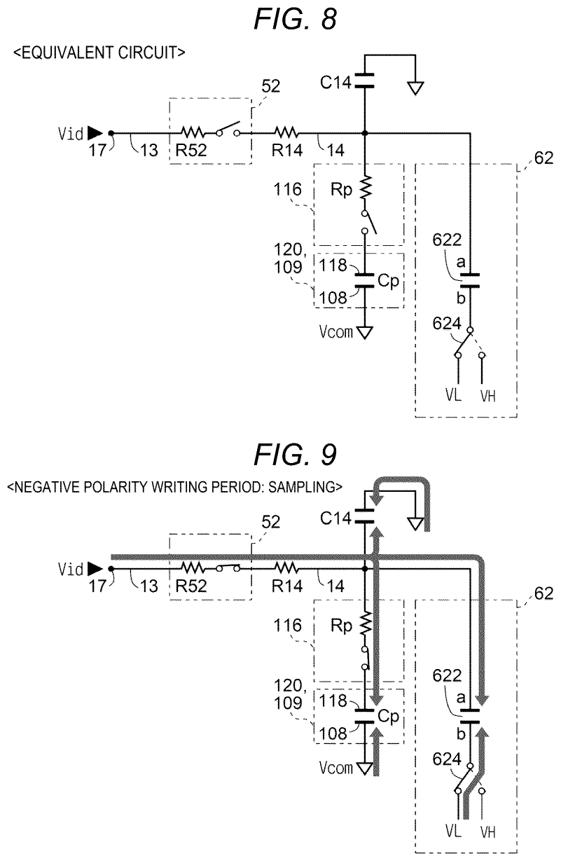

FIG. 8 shows an equivalent circuit of a main part in the electro-optical device 10.

Specifically, FIG. 8 shows an equivalent circuit of a configuration from the terminal 17 to the data signal line 13, the transistor 52, the data line 14, the transistor 116, the liquid crystal element 120, the storage capacitor 109, and the level shift circuit 62.

The transistor 52, the data line 14, and the level shift circuit 62 are used when the series of data lines or the like are not specified.

A resistor R52 is a resistance component when the transistor 52 is in the on-state. A resistor R14 is a resistance component of the data line 14, and a capacitor C14 is a parasitic capacitance component of the data line 14. A resistor Rp is a resistance component when the transistor 116 is in the on-state. The capacitor Cp is a parallel capacitor of the liquid crystal element 120 and the storage capacitor 109.

FIG. 9 shows the operation in a sampling period in the negative polarity writing period using the equivalent circuit shown in FIG. 8.

The sampling period is a period for sampling and holding the data signal supplied via the terminal 17 and the data signal line 13 in the data line 14. Specifically, the sampling period refers to the period in which the control signal Sel(1) is at the H level in the first series of the period in which the scanning signal is at the H level, and refers to the period in which the transistors 52a and 116 are in the on-state.

Note that the sampling period in the second series refers to the period in which the control signal Sel(2) is at the H level, and similarly, the sampling period in the third series refers to the period in which the control signal Sel(3) is at the H level.

In the sampling period of the negative polarity writing period, the voltage of the data signal corresponding to the negative polarity is first applied to one end of the capacitor C14, second applied to one end a of the capacitive element 622, and third applied via the transistor 116 in the on-state to the pixel electrode 118, which is one end of the capacitor Cp, via the data signal line 13, the transistor 52, and the data line 14.

When the sampling period ends in the horizontal scanning period (H) of the negative polarity writing period, the transistor 52 changes to the off-state. Further, when the horizontal scanning period (H) ends, the transistor 116 changes to the off-state. In the horizontal scanning period (H) of the negative polarity writing period, the control signals Ls(1) to Ls(3) are at the L level, the switch 624 maintains the selection of the voltage VL.

Therefore, even when the horizontal scanning period (H) of the negative polarity writing period ends, the data line 14 is temporarily held at the voltage of the sampled data signal corresponding to the negative polarity by the capacitor C14 and the capacitive element 622.

The other end of the capacitor Cp is the common electrode 108 and is constant at the voltage Vcom. Therefore, the voltage of the data signal corresponding to the negative polarity applied to the pixel electrode 118 is held by the capacitor Cp.

As is well known, in the liquid crystal element 120, alignment of liquid crystal molecules changes in accordance with an electric field generated by the pixel electrode 118 and the common electrode 108. Therefore, the liquid crystal element 120 is provided with transmittance according to the effective value of the applied voltage.

In the present embodiment, a normally black mode in which the transmittance is the lowest when the voltage applied to the liquid crystal element 120 is zero and the transmittance increases as the applied voltage increases is set.

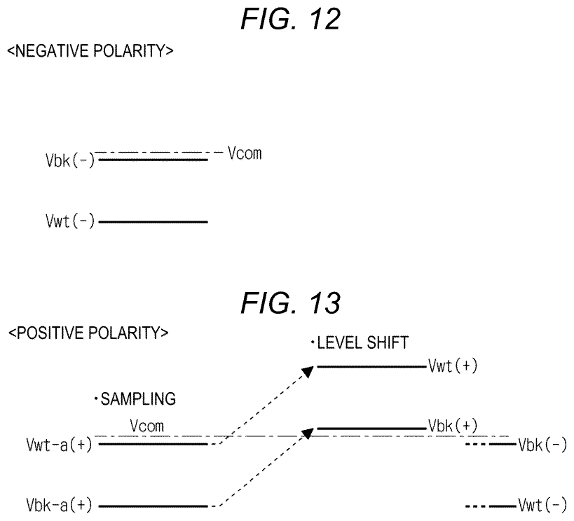

FIG. 12 shows a voltage of a data signal corresponding to negative polarity. The voltage of the data signal corresponding to the negative polarity is a voltage Vbk(−) lower than the voltage Vcom when the transmittance of the liquid crystal element 120 should be minimized, that is, when the gray level is the minimum value, and becomes lower than the voltage Vbk(−) as the transmittance increases, that is, as the gray level increases.

In the voltage of the data signal corresponding to the negative polarity, when the transmittance of the liquid crystal element 120 should be maximized, that is, when the gray scale is the maximum value, the voltage is a voltage Vwt(−).

When the frame period (V) for the negative polarity writing period ends, the frame period (V) for the positive polarity writing period starts. The positive polarity writing period is different from the negative polarity writing period in that a level shift period is provided after the sampling period.

The level shift period is a period in which the voltage of the sampled data signal is changed after the elapse of the sampling period, and refers to a period in which the control signals Ls(1) to Ls(3) sequentially become the H level in the first to third series.

In the present embodiment, the voltage is increased as the level shift, but the voltage may be decreased as described later.

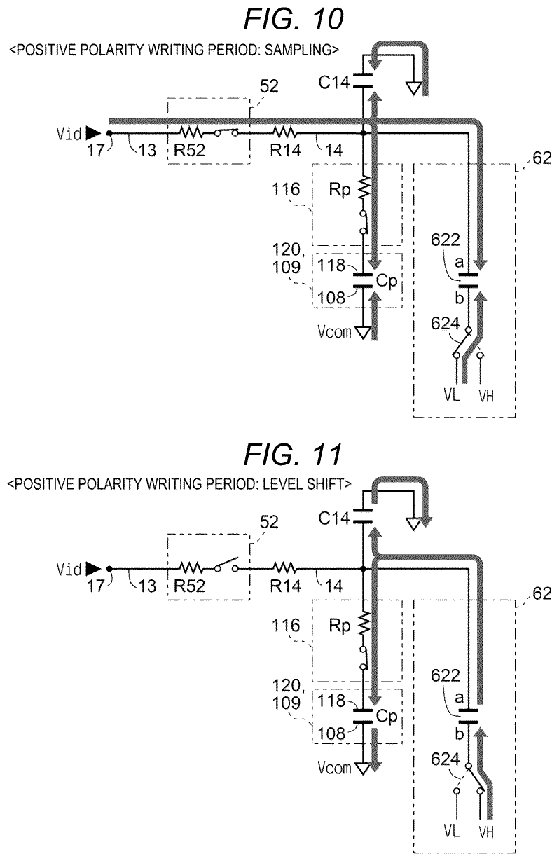

FIG. 10 shows the operation in the sampling period in the positive polarity writing period using the equivalent circuit shown in FIG. 8.

Similarly to the sampling period of the negative polarity writing period, the sampling period of the positive polarity writing period is a period in which the control signal Sel(1) is at the H level in the first series of the period in which the scanning signal is at the H level.

Therefore, similarly to the sampling period of the negative polarity writing period, in the sampling period of the positive polarity writing period, the voltage of the data signal is first applied to one end of the capacitor C14, second applied to one end a of the capacitive element 622, and third applied via the transistor 116 in the on-state to one end of the pixel electrode 118 as one end of the capacitor Cp via the data signal line 13, the transistor 52, and the data line 14. However, the positive data signal has a different voltage relationship from the negative data signal.

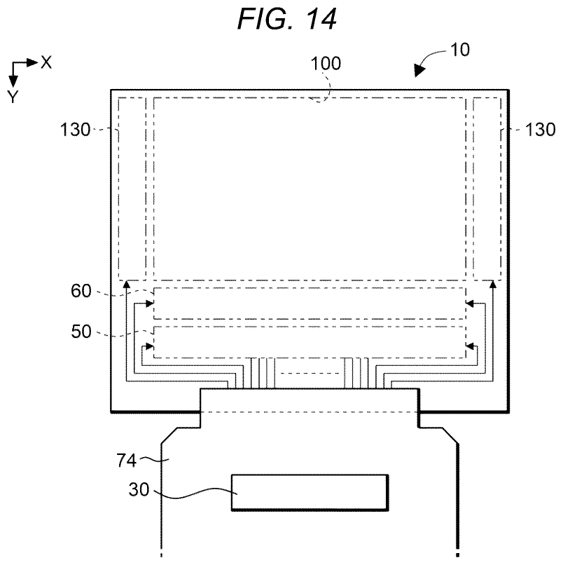

FIG. 13 shows a voltage of a data signal corresponding to positive polarity. The voltage of the data signal corresponding to the positive polarity is a voltage Vwt-a(+) lower than the voltage Vcom when the transmittance of the liquid crystal element 120 should be maximized, and becomes lower than a voltage Vwt-a(+) as the transmittance increases. The voltage of the data signal corresponding to the positive polarity is a voltage Vbk-a(+) when the transmittance of the liquid crystal element 120 should be minimized. That is, the relationship between the transmittance (gray level) and the level of the voltage is reversed between the positive polarity and the negative polarity.

Here, in order to simplify the description, in the positive polarity writing, the voltage Vwt-a(+) of the data signal when the transmittance of the liquid crystal element 120 should be maximized is lower than the voltage Vcom, but may be equal to or higher than the voltage Vcom.

When the sampling period ends in the horizontal scanning period (H) of the positive polarity writing period, the transistor 52 changes to the off-state. Then, after the time td has elapsed from the end of the sampling period, the level shift period starts.

FIG. 11 shows the operation in the level shift period in the positive polarity writing period using the equivalent circuit shown in FIG. 8. In the level shift period of the positive polarity writing period, the switch 624 switches the selection from the voltage VL to the voltage VH when the transistor 116 is in the on-state and the transistor 52 is in the off-state.

Therefore, the other end b of the capacitance element 622 rises from the voltage VL to the voltage VH, the charge charged in the capacitance element 622 flows out and raises the voltages of one end of the capacitor C14 and the pixel electrode 118 as one end of the capacitor Cp.

Specifically, it is necessary to consider the resistance Rp, the on-resistance of the switch 624, and the like for the voltage rise of the pixel electrode 118 by the level shift, but approximately, a value obtained by distributing the voltage rise (VH−VL) at the other end b at a ratio determined by the capacitance of the capacitive element 622 and the capacitors C14 and Cp is used.

It is preferable that the voltage range of the positive data signal becomes symmetrical to the voltage range of the negative data signal with respect to the voltage Vcom due to the voltage rise in the level shift period.

That is, as shown in FIG. 13, it is preferable that the voltage Vwt(+) when the voltage Vwt_a(+) is level-shifted is symmetrical to the voltage Vwt(−) with respect to the voltage Vcom, and the voltage Vbk(+) when the voltage Vbk_a(+) is level-shifted is symmetrical to the voltage Vbk(−) with respect to the voltage Vcom.

In other words, the voltages VH and VL and the capacitance of the capacitive element 622 may be determined in consideration of the resistor Rp determined by the electro-optical device 10, the on-resistance of the switch 624, and the capacitors C14 and Cp so as to have the symmetrical relationships described above.

However, in consideration of push-down occurring in the transistor 116, leakage of the transistor 116, and the like, a voltage range obtained by level-shifting the voltage of the positive data signal and a voltage range of the negative data signal may be set in an asymmetric relationship with respect to the voltage Vcom.

In the horizontal blanking period in which the scanning signal is at the L level, the level shift periods from the first series to the third series end in order. When the level shift period ends, the switch 624 switches the selection from the voltage VH to the voltage VL, but since the scanning signal has already become the L level and the transistor 116 is in the off-state, the voltage of the pixel electrode 118 as one end of the capacitor Cp does not fluctuate and is maintained in the level-shifted state. This state continues until the frame period (V) elapses and the next negative polarity writing is performed.

In the present embodiment, since the times when the level shift periods end are different from the first series to the third series, it is possible to suppress noise generated due to a voltage change as compared with a configuration in which the level shift periods end at the same time.

When the common electrode 108 is constant at the voltage Vcom, in the configuration without level shift, it is necessary for the display control circuit 30 to generate the data signal in the range from the voltage Vwt(−) to the voltage Vwt(+).

In contrast, in the present embodiment, the range from the voltage Vbk-a(+) to the voltage Vwt-a(+) of the positive data signal rises to the range from the voltage Vbk(+) to the voltage Vwt(+) due to level shift. Since the range from the voltage Vbk-a(+) to the voltage Vwt-a(+) of the positive data signal is substantially equal to the range from the voltage Vwt(−) to the voltage Vwt(+) of the negative data signal, the voltage range of the data signal output by the display control circuit 30 can be suppressed to substantially half as compared with the configuration without level shift.

Therefore, in the present embodiment, since the withstand voltage in the display control circuit 30 is suppressed to substantially half as compared with the configuration without level shift, the transistor size forming the display control circuit 30 can be reduced accordingly. Therefore, the chip size and cost of the display control circuit 30 can be reduced.

Further, in the present embodiment, since the voltage Vcom applied to the common electrode 108 is constant, it is possible to suppress deterioration in display quality caused by switching the voltage Vcom and an increase in power consumed by parasitic capacitance.

In the present embodiment, as a mode of level shift, the voltage of the data signal corresponding to the positive polarity is increased by level shift, but conversely, the voltage of the data signal corresponding to the negative polarity may be decreased by level shift.

Further, the data signal corresponding to the positive polarity may be increased by level shift and the data signal corresponding to the negative polarity may be decreased by level shift.

In the present embodiment, the auxiliary circuit 60 is provided at a position opposite to the distribution circuit 50 with respect to the display region 100, but may be provided at a position between the display region 100 and the distribution circuit 50 as illustrated in FIG. 14.

In FIG. 14, the control signals Ls(1) to Ls(3) to the auxiliary circuit 60 are preferably supplied from both left and right sides in order to suppress the influence of delays, similarly to the configuration shown in FIG. 2.

In the embodiment, the number k of the data lines 14 forming one group is described as “3”, but the number k may be “1” and the data signal may not be distributed, or the number k may be an integer of “2” or “4” or more and the data signal may be distributed.

Next, a projection-type display apparatus will be described as an example of an electronic apparatus to which the electro-optical device 10 according to the embodiment and the like is applied.

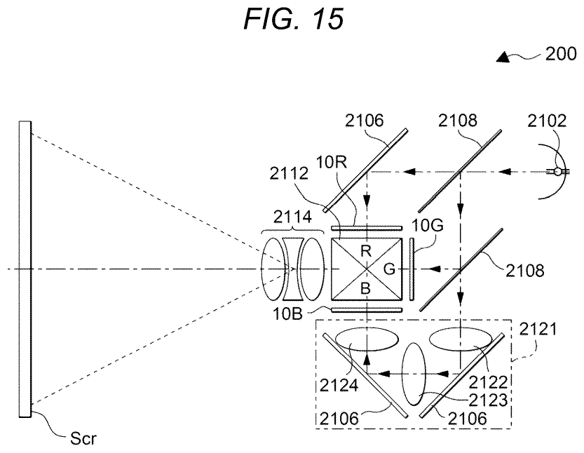

FIG. 15 shows an optical configuration of a projection-type display apparatus 200. As illustrated in the drawing, the projection-type display apparatus 200 includes electro-optical devices 10R, 10G, and 10B.

A lamp unit 2102 formed of a white light source such as a halogen lamp or an LED is provided inside the projection-type display apparatus 200. Light emitted from the lamp unit 2102 is separated into three primary colors of red (R), green (G), and blue (B) by three mirrors 2106 and two dichroic mirrors 2108 disposed inside. Of the lights, the R light is incident on the electro-optical device 10R, the G light is incident on the electro-optical device 10G, and the B light is incident on the electro-optical device 10B.

Note that, since the B optical path is longer than the R optical path and the G optical path, it is necessary to prevent a loss in the B optical path. Therefore, a relay lens system 2121 including an incident lens 2122, a relay lens 2123, and an exit lens 2124 is provided in the B optical path.

The electro-optical devices 10R, 10G, and 10B are common to the electro-optical device 10 according to the embodiment and the like, but are distinguished by signs for convenience since the colors of the incident lights are different.

The liquid crystal element of the electro-optical device 10R is driven based on the data signal corresponding to R supplied from the upper circuit, and thus has transmittance corresponding to the voltage of the data signal. Therefore, in the electro-optical device 10R, an R transmission image is generated by individually controlling the transmittances of the liquid crystal elements.

Similarly, in the electro-optical device 10G, a G transmission image is generated based on the data signal corresponding to G, and in the electro-optical device 10B, a B transmission image is generated based on the data signal corresponding to B.

The transmission images of the respective colors respectively generated by the electro-optical devices 10R, 10G, and 10B are incident on the dichroic prism 2112 from three directions. In the dichroic prism 2112, the R light and the B light are refracted by 90 degrees, while the G light travels straight. Accordingly, the dichroic prism 2112 combines the images of the respective colors. The combined image by the dichroic prism 2112 enters a projection lens 2114. The projection lens 2114 enlarges and projects the combined image on a screen Scr.

Note that the transmission images by the electro-optical devices 10R and 10B are reflected by the dichroic prism 2112 and projected, whereas the transmission image by the electro-optical device 10G travels straight and is projected. Therefore, the respective transmission images by the electro-optical devices 10R and 10B have a left-right inverted relationship with respect to the transmission image of the electro-optical device 10G.

Here, the projection-type display apparatus 200 is exemplified as the electronic apparatus, but the present disclosure is not limited thereto, and is also applicable to, for example, a display panel of a head-mounted display, an electronic viewfinder in a video camera, a lens-interchangeable digital camera, or the like, a portable information terminal, a display unit of a wristwatch, or the like.

From the embodiment exemplified above, for example, the following configurations are grasped.

An electro-optical device according to an aspect of the present disclosure includes a pixel circuit including a liquid crystal element in which liquid crystal is sandwiched between a pixel electrode and a common electrode, and a first switch provided between the pixel electrode and a data line to which a data signal is supplied, a second switch provided between a terminal that receives input of the data signal and the data line, and a level shift circuit that level-shifts, during a period in which the second switch is in an off-state, a voltage of the data signal supplied to the data line during a period in which the second switch is in an on-state.

According to the electro-optical device of the configuration 1, it is possible to alternating-current drive the liquid crystal element with the voltage of the common electrode constant and the suppressed voltage amplitude of the data signal. Therefore, power consumption can be suppressed without adversely affecting display quality.

The transistor 116 is an example of “the first switch”, the transistor 52 is an example of “the second switch”, and the terminal 17 is an example of “the terminal that receives input of the data signal”.

In the electro-optical device according to a specific configuration 2 of the configuration 1, the level shift circuit starts the level shift in a period in which the first switch is in an on-state.

According to the electro-optical device of the configuration 2, the voltage applied to the pixel electrode is level-shifted in electrical coupling to the data line.

In the electro-optical device according to another specific configuration 3 of the configuration 1, the second switch is a switch that distributes the data signal input to the terminal to two or more data lines.

According to the electro-optical device of the configuration 3, the second switch can also be used as a switch that distributes the data signal input to the terminal to two or more data lines.

In the electro-optical device according to another specific configuration 4 of the configuration 2, the level shift circuit starts the level shift after the second switch transitions from the on-state to the off-state, and ends the level shift after the first switch transitions to the off-state.

According to the electro-optical device of the configuration 4, the data signal sampled to the data line is level-shifted when the first switch is in the on-state and the second switch transitions from the on-state to the off-state, and the level-shifted voltage is determined when the first switch is in the off-state.

In the electro-optical device according to another specific configuration 5 of the configuration 1, the level shift circuit includes a capacitive element having a first end and a second end, the first end being electrically coupled to the data line, and a voltage change circuit that changes a voltage of the second end.

According to the electro-optical device of the configuration 5, the level shift circuit can be configured with the capacitive element and the voltage changing circuit coupled to each other.

The capacitive element 622 is an example of “the capacitive element”, one end a is an example of “the first end”, and the other end b is an example of “the second end”.

In the electro-optical device according to another specific configuration 6 of the configuration 5, the voltage change circuit is a third switch that selects either a relatively high voltage or a relatively low voltage and applies the selected voltage to the second end.

In the electro-optical device according to the configuration 6, the third switch as the voltage change circuit can be configured with a double-throw switch that selects two terminals.

Note that, as for the relatively high voltage and the relatively low voltage, a higher voltage of the two voltages is referred to as “the high voltage”, and a lower voltage is referred to as “the low voltage”. The switch 624 is an example of “the third switch”.

In the electro-optical device according to another specific configuration 7 of the configuration 1, the level shift circuit executes the level shift to increase the voltage of the data signal supplied to the data line when the pixel electrode is set at a higher voltage than that of the common electrode, and does not execute the level shift when the pixel electrode is set at a lower voltage than that of the common electrode.

According to the electro-optical device of the configuration 7, the level shift is executed in so-called positive polarity writing, and the level shift is not executed in negative polarity writing.

In the electro-optical device according to another specific configuration 8 of the configuration 1, the level shift circuit is provided between the second switch and the pixel circuit or at a side opposite to a point where the second switch is provided with respect to the pixel circuit.

According to the electro-optical device of the configuration 8, when a plurality of the pixel circuits are provided corresponding to the data lines, the level shift circuit can be disposed without affecting the arrangement of the pixel circuits.

An electronic apparatus according to a configuration 9 includes the electro-optical device according to any one of the configurations 1 to 8.

What is claimed is:

1. An electro-optical device, comprising:
a pixel circuit including a liquid crystal element in which liquid crystal is sandwiched between a pixel electrode and a common electrode, and a first switch provided between the pixel electrode and a data line to which a data signal is supplied;
a second switch provided between a terminal that receives input of the data signal and the data line; and
a level shift circuit that level-shifts, during a period in which the second switch is in an off-state, a voltage of the data signal supplied to the data line during a period in which the second switch is in an on-state.

2. The electro-optical device according to claim 1, wherein
the level shift circuit starts the level shift in a period in which the first switch is in an on-state.

3. The electro-optical device according to claim 1, wherein
the second switch is a switch that distributes the data signal input to the terminal to two or more data lines.

4. The electro-optical device according to claim 2, wherein
the level shift circuit starts the level shift after the second switch transitions from the on-state to the off-state, and ends the level shift after the first switch transitions to the off-state.

5. The electro-optical device according to claim 1, wherein
the level shift circuit includes:
a capacitive element having a first end and a second end, the first end being electrically coupled to the data line; and
a voltage change circuit that changes a voltage of the second end.

6. The electro-optical device according to claim 5, wherein
the voltage change circuit is a third switch that selects either a relatively high voltage or a relatively low voltage and applies the selected voltage to the second end.

7. The electro-optical device according to claim 1, wherein
the level shift circuit executes the level shift to increase the voltage of the data signal supplied to the data line when the pixel electrode is set at a higher voltage than that of the common electrode, and does not execute the level shift when the pixel electrode is set at a lower voltage than that of the common electrode.

8. The electro-optical device according to claim 1, wherein
the level shift circuit is provided between the second switch and the pixel circuit or at a side opposite to a point where the second switch is provided with respect to the pixel circuit.

9. An electronic apparatus, comprising the electro-optical device according to claim 1.
